(19) United States
(12) Patent Application Publication
(10) Pub. No.: US 2014/0113841 A1
(43) Pub. Date: Apr. 24, 2014

(54) BUBBLE-ENHANCED PROPPANT FOR WELL FRACTURING

(71) Applicants: Arthur I. Shirley, Hillsborough, NJ (US); Eugene Wexler, Summit, NJ (US); Patrick Schneider, Richmond, TX (US); Robin Watts, Smithville, TX (US)

(72) Inventors: Arthur I. Shirley, Hillsborough, NJ (US); Eugene Wexler, Summit, NJ (US); Patrick Schneider, Richmond, TX (US); Robin Watts, Smithville, TX (US)

(21) Appl. No.: 14/056,997

(22) Filed: Oct. 18, 2013

Related U.S. Application Data
(60) Provisional application No. 61/715,351, filed on Oct. 18, 2012.

(51) Int. Cl. C09K 8/66

(52) U.S. Cl. CPC C09K 8/665
USPC 507/202

(57) ABSTRACT

Stable, gas-filled bubbles on the surface of proppant particles are formed by placing proppant in selected organic solvent having a much greater solubility of a selected gas compared to water, pressurizing the solvent with the selected gas, e.g., nitrogen, at pressures equal of greater than the operating pressure for a set time period to achieve saturation, and then replacing the solvent with water before reducing the pressure back to operating pressure level to create a local supersaturation near the solvent-solid interface, which will result in gas-filled bubble formation on the surface of proppant particles. The pressurized mixture of bubble surrounded proppant particles and water can then be combined with a respective fracturing fluid, e.g., slick water or carbon dioxide and/or nitrogen foam or an emulsion, which can be used in oil or gas producing wells to improve efficiency of hydraulic fracturing thereof.

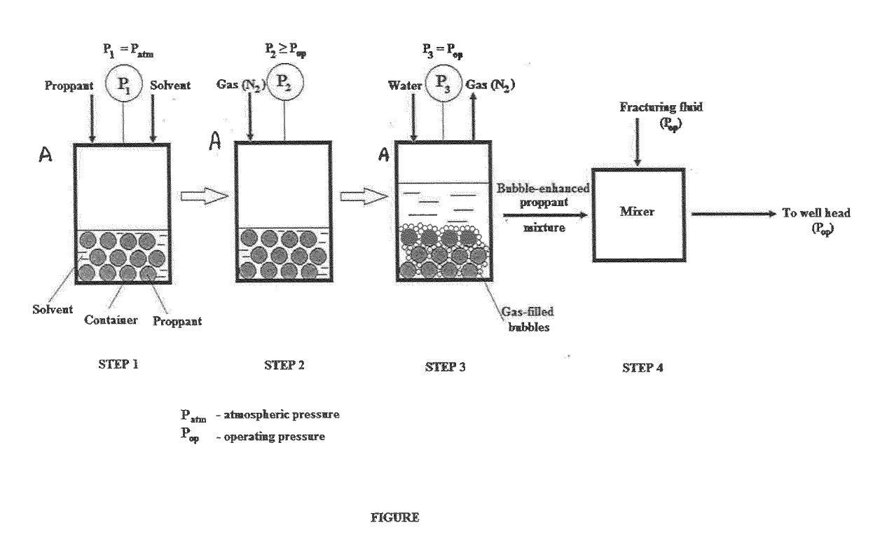

### CROSS REFERENCE TO RELATED APPLICATIONS

This application claims priority from U.S. provisional application Ser. No. 61/715,351 filed Oct. 18, 2012.

### BACKGROUND OF THE INVENTION

The generation of gas-filled bubbles of various sizes, including nano- and/or micro-sized bubbles, on solid surfaces has been accomplished in a variety of manners. For example, physical irritation is applied to microbbubbles contained in a liquid so that the microbubbles are abruptly contracted to form nanobubbles. Alternatively, nanobubbles have been produced by a nanobubble-generating nozzle capable of generating nanobubbles by allowing gas to flow in flowing liquid without a separate device for mixing bubbles. Nanobubbles have also been created employing filtering through a porous media.

In the production of natural gas from shale or other “tight-gas” formations, hydraulic fracturing (or “frac”) is used to break up the rock around the well bore and reduce the resistance to gas flow. The frac technique generally requires injecting into the well large amounts of fluids, which are more compressible like nitrogen-based foams or less compressible, like carbon dioxide based foams or other water- or hydrocarbon based fluids (e.g., liquefied petroleum gas fluid). The fluids are pumped downhole at high pressures to create large compressive forces around the well bore that would break the rock and create fractures, and also to efficiently carry proppant (small and strong solid particles, e.g. sand) to place inside such fractures to prevent them from closure upon pressure release. The fluids can be pumped to depths 10,000 to 20,000 feet below the surface of the earth using conventional (vertical) and unconventional (horizontal) drilling techniques. Ideal fracturing fluid must be able to carry proppant (typically 0.2 to 5 pounds per gallon) long distance and in the suspended state to ensure optimal placement and creation of effective fracture networks for oil and/or gas to flow to the well bore and then to the surface. This could be challenging since the specific gravity of the proppant exceeds that of the fracturing fluid.

One of the parameters affecting oil and gas production from the well is the conductivity of proppant arrangement once it is settled within the fissures. This is directly related to proppant load and distribution within the fracturing fluid, as well as the ability of such mixture to penetrate small-size fractures and specifically, secondary fracture networks characterized by sub-millimeter widths and heights and often quite significant lengths. Enabling access to such secondary fracture networks may result in up to a 15% increase in hydrocarbon production. The non-uniform distribution of the proppant results in uncontrolled proppant placement which may simply block the passages.

An ideal fluid/proppant mixture, for example, would contain reduced amounts of a uniformly distributed proppant to enable the uniform placement thereof within fractures. A single layer of proppant particles may be enough to keep the fracture open while providing optimal conductivity. This would require lower specific gravity of the proppant to enable uniform distribution, delivery and placement and high strength/crush resistance to withstand high formation pressures/closure stresses.

Currently, the proppant market worldwide is approximately 17 billions pounds per year, 99% of which consists of sand, resin-coated sand and ceramic proppants. For extremely deep wells, super strong proppants (e.g., bauxite) are used, but they are more expensive and have even higher specific gravity, which makes them much more difficult to suspend within fracturing fluid. Despite a number of efforts to develop light and ultra-light weight strong proppants, the majority of these have limited applications and remain cost prohibitive. The smaller diameter, spherical sand particles thus remain the most preferred and cost-effective solution.

Therefore, it is desirable to enable more uniform distribution, delivery and placement of reduced loads of proppant using conventional and unconventional fracturing fluids such as slick water and carbon dioxide/nitrogen emulsions/foams respectively.

The invention is a method for the production of an enhanced proppant and its suspension within a fracturing fluid. Stable gas-filled bubbles, including nanobubbles and/or microbubbles, are generated in-situ on the surface of proppant particles and these modified proppant particles can be used with conventional water-based (for example, slick water), hydrocarbon-based such as liquefied natural gas (LNG) or liquefied petroleum gas (LPG) and/or energized fracturing fluids (carbon dioxide/nitrogen emulsions and/or foams). The gas-filled bubbles can reduce the effective specific gravity of the proppant particles and enable a more uniform distribution of the proppant within the fracturing fluid and delivery into small-size fractures, particularly secondary fracture networks.

### SUMMARY OF THE INVENTION

This objective may be realized by a method for forming gas-filled bubbles on a surface of a proppant particle comprising the steps of placing the proppant particle in water at an operating pressure, pressurizing the water with a gas at pressures equal to or greater than the operating pressure to create saturation around or in the vicinity of the proppant particle and releasing excess pressure from the water to the operating pressure level.

The operating pressure is typically between 8,000 and 12,000 pounds per square inch (psi).

The proppant particle that may be employed is selected from the group consisting of sand, resin-coated sand, ceramic, hollow ceramic and bauxite, and mixtures of these.

The gas that is used to pressurize the water and/or organic solvent mixture is selected from the group consisting of nitrogen, argon, methane, carbon dioxide, hydrogen and helium and mixtures of these.

The gas-filled bubbles that are formed are typically in the size range of micro- to nano-. The gas-filled bubbles will lower the effective specific gravity of the proppant particles.

In an alternative embodiment of the invention, the proppant particle can be added to an organic solvent having a higher solubility for the gas than the water and the mixture of organic solvent and proppant particle can be added to the water. This will help achieve saturation around or on the surface of the proppant particle more efficiently. The method continues with water being added to supplant the organic solvent until the excess pressure if any is released from the water.

The organic solvent is typically an alcohol/water mixture where alcohols are selected from the group containing methanol, ethanol, propanol and their mixtures

The produced gas-filled bubble on the surface of a proppant particle can be added to a well that is producing oil and/or gas that is to be fractured. The produced proppant particle would typically be added to the well in a medium selected from the group consisting of water-based and/or hydrocarbon-based fluids, energized foam and emulsion.

### BRIEF DESCRIPTION OF THE DRAWINGS

The figure is a schematic of a method for forming bubbles on the surface of a proppant and combining the treated proppant with the fracturing fluid for addition to a gas or oil producing well.

### DETAILED DESCRIPTION OF THE INVENTION

The invention is a method for producing an enhanced proppant for use in a fracturing operation. By creating gas-filled bubbles on the surface of the proppant particles, the proppant itself is not altered. This will result in a better distribution of the proppant within the fracturing fluid, better delivery of proppant and more uniform placement of proppant in the well fractures to enable high conductivity. A conventional, low-cost proppant can then be employed by creating the bubbles, including nano- and/or micro-bubbles, on the surface of the proppant in lieu of using a more expensive proppant material by itself, or altering the proppant material outright. The invention will further provide for a reduction in the specific gravity of the proppant used in a fracturing operation.

Turning to the figure, during Step 1, the solvent (e.g., ethanol) and proppant (e.g., 50/50 mesh sand) are added to a container A. During Step 2, the container is pressurized with gas (e.g., nitrogen) to pressures equal to or greater than the operating pressure to achieve saturation. During Step 3, water is added to the container to supplant the organic solvent present therein. Once water replaces the organic solvent and the pressure of the system is reduced to the operating pressure level (if applicable), a supersaturation near solid-liquid interface occurs, resulting in bubble nucleation on the surface of the proppant particles. The pressurized mixture of the water and bubble-surrounded proppant particles is then fed to a mixer, where it mixes with a respective fracturing fluid (e.g., slick water with additives) and the mixture is supplied to the well head.

In another embodiment of the invention, the water in the first step is not mixed with a surfactant or foaming agent and it is supplied to container A that is not prefilled with an organic solvent but is prefilled with water. The water that is then used to supplant the organic solvent will merely supplant water already present in the container A while the pressure of the system is reduced if necessary to the operating pressure level.

The gases that can be employed in the fracturing fluid are selected from the group consisting of nitrogen, argon, methane, carbon dioxide, helium and hydrogen.

Fracturing fluids are conventional types frequently used in fracturing gas and oil wells such as water-based (for example, slick water), hydrocarbon-based such as liquefied natural gas and liquefied petroleum gas, carbon dioxide and/or nitrogen emulsions/foams, including nano-particle stabilized foams as well as gelled/foamed liquid petroleum gas/liquefied natural gas mixtures.

The bubble-surrounded proppant-fracturing fluid mixture may comprise two or more different gases such as a mixture of carbon dioxide and nitrogen.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for forming gas-filled bubbles on a surface of a proppant particle comprising the steps of placing the proppant particle in water at an operating pressure, pressurizing the water with a gas to a pressure equal to or greater than the operating pressure to create saturation around or in the vicinity of the proppant particle and releasing the pressure from the water to the operating pressure level.

2. The method as claimed in claim 1 wherein the proppant particle is selected from the group consisting of sand, resin-coated sand, ceramic, hollow ceramic and bauxite, and mixtures of these.

3. The method as claimed in claim 1 wherein the gas is selected from the group consisting of nitrogen, argon, methane, carbon dioxide, hydrogen and helium and mixtures of these.

4. The method as claimed in claim 1 wherein the gas-filled bubbles are nanobubbles or microbubbles.

5. The method as claimed in claim 1 wherein the proppant particle is added to a well producing oil and/or gas to be fractured.

6. The method as claimed in claim 1 wherein the proppant particle is added to the well in medium selected from the group consisting of water-based, hydrocarbon-based, carbon dioxide and/or nitrogen foam and/or emulsion.

7. The method as claimed in claim 6 wherein the water-based medium is slick water.

8. The method as claimed in claim 6 wherein the hydrocarbon-based medium is selected from the group consisting of liquefied natural gas and liquefied petroleum gas.

9. The method as claimed in claim 1 wherein the gas-filled bubbles lower the effective specific gravity of the proppant particles.

10. The method as claimed in claim 1 further comprising adding the proppant particle to an organic solvent having a higher solubility for the gas than the water and pressurizing the solvent with a gas to a pressure equal to or greater than the operating pressure and then substituting the solvent with water to create saturation around or in the vicinity of the proppant particle before releasing the pressure from the water.

11. The method as claimed in claim 10 wherein the organic solvent is selected from the group consisting of methanol, ethanol, propanol and their mixtures with water and mixtures thereof.
